(19) United States
(12) Patent Application Publication
(10) Pub. No.: US 2005/0039423 A1
(43) Pub. Date: Feb. 24, 2005

(54) Girth strap device

(76) Inventors: Niall Finn, Lethbridge (AU); Ronald Francis Slocombe, Strathmore (AU); John Robert Bowers, Mount Martha (AU)

Correspondence Address: MERCHANT & GOULD PC, P.O. BOX 2903, MINNEAPOLIS, MN, 55402-0903, US

(21) Appl. No.: 10/489,502

(22) PCT Filed: Sep. 12, 2002
(86) PCT No.: PCT/AU02/01247

(30) Foreign Application Priority Data
Sep. 12, 2001 (AU) PR 7642

(51) Int. Cl. B68C 1/00

(52) U.S. Cl. 54/23

(57) ABSTRACT

A girth strap device is provided which includes an elongate strap or band (1;11) adapted to extend around the chest of an animal and attachments (3;20) for attaching the strap (1;11) to an article, such as a saddle (4) for holding the strap or band (1;11) in tension. The girth strap includes a tension indicator (5;15) which allows a user to apply the strap to the animal at a selected tension. In one preferred construction, the strap (1;11) is formed from layers of alastomeric fabric material, such a neoprene, which can stretch as the animal's chest expands during breathing and movement without causing discomfort to the animal. The device has particular application to racehorses and allows a user to apply a selected tension within an optimum range from about 10 kg to about 12 kg which is sufficient to hold a saddle securely on the horse without excessive tension restricting the performance of the horse.

### FIELD OF THE INVENTION

This invention relates to straps or similar devices used for fitting and securing objects to an animal's body and includes devices for supporting parts of an animals body. In particular, this invention relates to an improved girth strap device for securing objects about the chest or lung region of an animal, such as a horse.

### BACKGROUND TO THE INVENTION

The secure fitting of an object to an animal's body is routinely accomplished in a number of ways. For example, dedicated clothing or fastening straps in many shapes and forms are well known and used. However, when an object is to be secured at or near the chest region of an animal the normal movement of this region by the action of breathing results in significant and rhythmic alteration of the chest girth of an animal Generally allowance is made for such movement by the use of elastic straps, or straps with elastic attachments at the ends. However, when maximum security is required for fitting, the straps used are often overtightened in an effort to ensure security. Such overtightening can pose problems. For example, when the device in question is a horse saddle the associated girth straps are often overtightened to maximise the security of saddle fitting to the horse. The traditional method and use of girth straps to secure a horse saddle are well established. Girth straps are attached to the saddle around the circumference of a horses chest. The girth strap is attached to the saddle by holed leather extensions that extend from the base of the saddle, to which they are firmly sewn, and are then passed through the buckles on each end of the girth. The girth is then clinched up to the desired tension by pulling the saddle leather strap through the buckle and set in the clasp. The ability to tension the leather girth strap correctly is an acquired art and research by the applicants has demonstrated that the personnel responsible for applying the girth strap to race horses, strappers, frequently overtighten the girth. Such an overtightening can potentially impede the breathing or muscle action of the animal around the chest

region or thoracic limbs and introduce discomfort. In the case of a race horse, such impediments can greatly reduce the racing performance of the animal.

It is desirable to provide an improved girth strap device in which at least some of the disadvantages of conventional girth straps are alleviated.

### SUMMARY OF THE INVENTION

According to one aspect of the invention, there is provided a strap device comprising a strap means adapted to extend around the chest region of an animal and attachment means for attaching the ends of the strap means to an article, so that the strap means can be held in tension about the chest region of the animal, wherein the strap means is formed from an extensible elastomeric fabric material having a pre-calibrated substantially uniform extension characteristic in the region of an optimum applied tension, and the strap device includes a tension indicator to allow a user to apply the strap means to the animal at a selected calibrated tension.

The tension indicator may be a visual indicator to readily indicate to a user when the strap means has assumed a selected tension about the chest region of an animal so that the means for attaching the strap can be applied to hold the strap at the selected tension about the animal.

The indicator may be incorporated in the strap means or may be an accessory for fitting to the strap. Alternatively, the indicator may be a permanent part of the strap means. The tension indicator is preferably provided at a position adjacent to the attachment means at at least one end of the strap means.

The tension indicator and the strap means are preferably adapted for relative movement when the strap means is extended.

The indicator may include at least one visual marking which is adapted for movement relative to the strap means in response to longitudinal extension of said strap means and particularly adapted to align with a marking on the strap means when a predetermined tension is applied to the strap. Preferably, the indicator and/or the strap device have a plurality of calibrated visual markings.

In another embodiment, the indicator may be a length of material attached at its ends to the strap means and which is adapted to form a loop in an unextended condition of the strap means and to lie substantially flat against the strap means when the strap means is extended to the selected tension.

The means for holding the strap in tension may comprise attachment means for attaching the ends of the strap means to an article, such as a saddle for the animal. In one preferred embodiment of a girth strap for a horse, the attachment means are in the form of buckles provided for attachment to apertured leather straps extending from the sides of a saddle for the horse.

Preferably, the strap means comprises a single elongate band of extensible elastomeric material that is adapted to stretch around the chest of the animal to apply the selected tension to the animal. Such an extensible elastomeric band having a substantially uniform extension characteristic in the region of an optimum applied tension can stretch as the animal's chest expands during breathing and movement without a significant increase in the tension applied to the animal which could cause discomfort to the animal.

According to another aspect of the invention, there is provided a girth strap device comprising an elongate band adapted to extend around the chest region of an animal and attachment means for securing the strap device to a saddle, wherein the elongate band is formed from an extensible elastomeric fabric material that is adapted to stretch around the chest of an animal, said band having a pre-calibrated substantially uniform extension characteristic in the region of an optimum applied tension, whereby a calibrated selected tension is applied to the animal when the elongate band has been stretched longitudinally by a selected amount, and the elongate band stretches substantially uniformly during breathing of the animal at tensions above the optimum applied tension.

An extensible elastomeric girth strap device in accordance with the invention which is particularly suitable for use with racehorses is preferably adapted to apply a selected tension falling substantially within the range from 5 kg to 20 kg, and more preferably a selected tension falling substantially within the range from 10 kg to 15 kg.

A particularly preferred form of girth strap in accordance with the invention has been developed using a band of extensible elastomeric material that is adapted to extend in length by from about 3% to about 7%, and more preferably by about 5% per kg of tension applied to the band.

In order to apply the selected tension to the animal, the elongate band is preferably adapted to extend in length by about 30% to about 70%, and more preferably by about 40% to 60% of its unextended length. In a particularly preferred embodiment, the elastomeric material used for the band is such that the band extends by about 50% of its length to provide a selected tension of about 10 kg.

When the girth strap device is tensioned around the animal the selected tension may be indicated by a tension indicator attached to or forming part of the strap device in accordance with the first aspect of the invention.

In a particularly preferred embodiment the band means of the strap device is a laminated construction of at least two layers of elastomeric fabric material. The elastomeric fabric material may be formed from a natural or synthetic elastomer, such as neoprene (polychloroprene) or other similar flexible foam material.

According to another aspect of the invention, there is provided a girth strap device comprising a single elongate band adapted to extend around the chest region of an animal, and attachment means at each end of the band for securing the strap device to an article, such as a saddle, wherein the single elongate band is a laminated construction of at least two layers of elastomeric fabric material

having a pre-calibrated substantially uniform extension characteristic-in the region of an optimum applied tension.

The layers of elastomeric fabric material may be secured together by an adhesive or other bonding means. Preferably an elastomeric adhesive is used which has similar stretch characteristics to the layers of elastomeric fabric material.

According to a further aspect of the invention there is provided a method of fitting a girth strap in accordance with the invention to a horse, wherein the girth strap is tightened to a selected tension falling substantially within the range from about 5 kg to 20 kg, and more preferably from about 10 kg to 15 kg.

In the method of the invention, preferably a tension indicator is used to indicate when the girth strap has been tightened to the selected tension.

### BRIEF DESCRIPTION OF THE DRAWINGS

The invention will now be described in more detail, by way of example only, with reference to the accompanying drawings, in which:

FIG. 1 shows one particular embodiment of the invention with the strap device applied to a horse for the purpose of securing a saddle;

FIG. 2 shows a schematic plan view of one end of a first embodiment of strap device of the invention;

FIG. 3 shows a side view of the strap device of FIG. 2;

FIG. 4 shows a second embodiment of the invention in schematic form;

FIG. 5 is a top plan view of another embodiment of a strap device in accordance with the invention;

FIG. 6 is a side view of the strap device of FIG. 5;

FIG. 7 is a top plan view of the strap device of FIG. 5 stretched to a selected tension;

FIG. 8 is a side view of the strap device shown in FIG. 7;

FIG. 9 is an enlarged plan view of the ends of the strap device of FIG. 5,

FIG. 10 is a section through the strap device on the line of FIG. 9;

FIG. 11 is a graph showing a comparison of girth strap extension against applied tension for conventional girth straps and for an ideal girth strap for a racehorse; and

FIG. 12 is a graph showing the stretch characteristic of a girth strap in accordance with the invention.

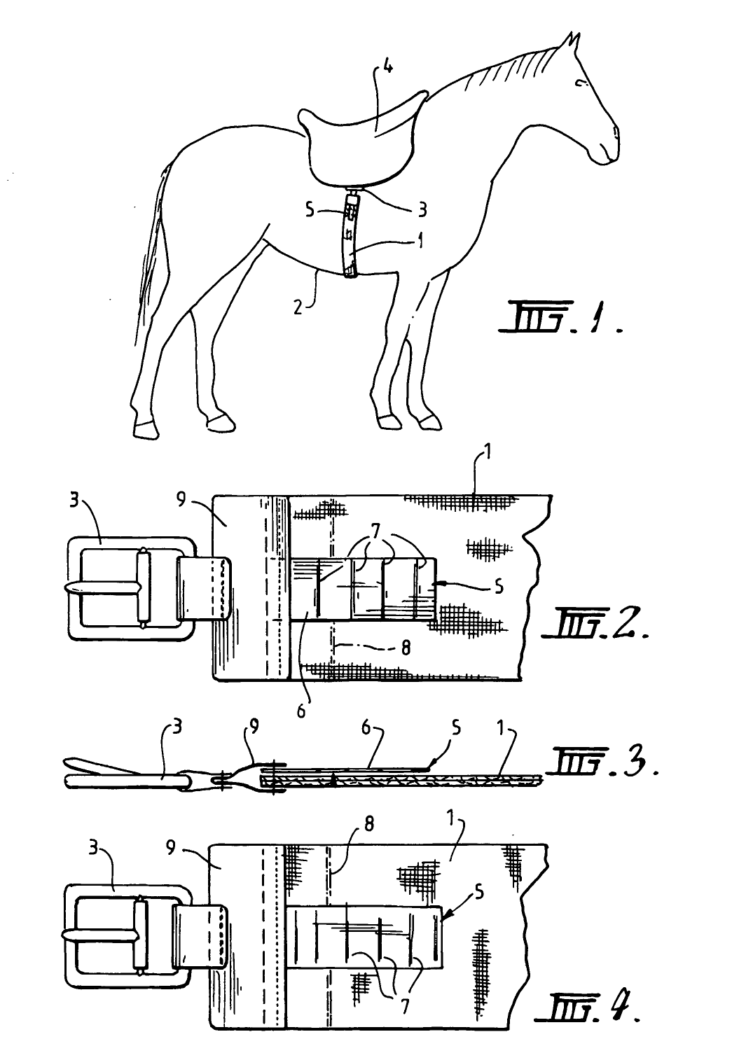

Referring firstly to FIG. 1, one particular embodiment of the invention is shown in the form of a strap device for securing a saddle 4 to a horse. The improved strap device of FIG. 1 comprises a strap means 1 in the form of a band which is adapted for traversing the chest region 2 of the animal in question. The strap means has fittings in the form of buckles 3 at each end and for holding the strap in tension about the chest region of the animal and for fitting to a saddle. The strap means 1 incorporates a tension indicator 5 which is adapted to move in response to tension applied to the strap means so as to allow a user to apply a known or calibrated tension to an animal when using the improved strap device of the invention.

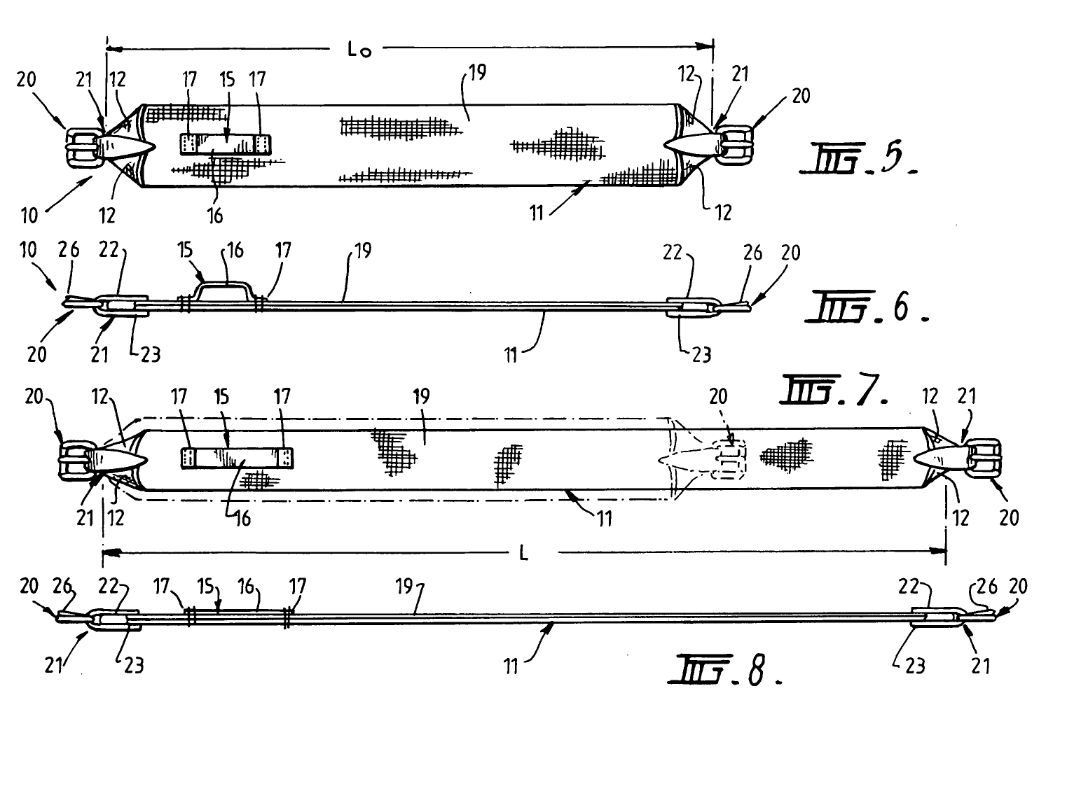

Referring now to FIGS. 2 and 3, a first embodiment of the invention is shown in the form of a simplified version of the improved strap device incorporating a strap and external visual indicator. In this particular embodiment of the invention the strap device incorporates a buckle 3 for fitting to a saddle or similar device. The buckle 3 is attached to an end of elastic strap means 1 by a securing member 9 such that the strap means 1 can be drawn around the chest region of an animal and secured by a second buckle or alternative fixing means on the other end of the strap to a saddle or similar device. The strap device 1 incorporates a tension indicator 5 in the form of a thong 6 fixed to the securing member 9 and marked with a plurality of visual bands 7. The thong 6 is adapted for differential movement relative to the elastic strap means 1 in response to tension applied to the strap means 1 such that a reference calibration mark 8 placed on said strap means will move relative to the visual bands 7 on the thong 6 as the strap means is drawn into tension. The thong 6 and strap means 1 can have a plurality of reference calibrations and visual bands as appropriate and the bands can be suitably calibrated so as to provide a ready visual reference to indicate a given amount of tension as applied to the strap means 1 as the strap means 1 is drawn around an animal's chest. For example, the thong may have calibrated bands or markings corresponding to applied tensions ranging from about 5 kg to about 20 kg.

In this manner the visual indicator of the invention provides a ready means of advising a user when the strap device of the invention has been applied to a given tension around an animal's chest region so as to provide a reference regarding the necessary tension as appropriate for a given situation.

Referring now to FIG. 4 an alternative embodiment of the invention is shown with an internally calibrated indicator system. A buckle 3 is fitted to a strap means 1 by a securing member 9 with a tension indicator in the form of a girth insert 5 comprising a webbing of differential elasticity to that of the elastic strap means 1. The girth insert 5 is provided with a plurality of visual bands 7 for alignment with a reference calibration 8 as applied to the strap means 1. This particular embodiment of the invention could also be used as an accessory or attachment to an existing girth system as well as an integral system. As in the embodiment of FIGS. 2 and 3, the visual bands 7 of the girth insert 5 may be calibrated with marks corresponding to applied tensions ranging from about 5 kg to about 20 kg.

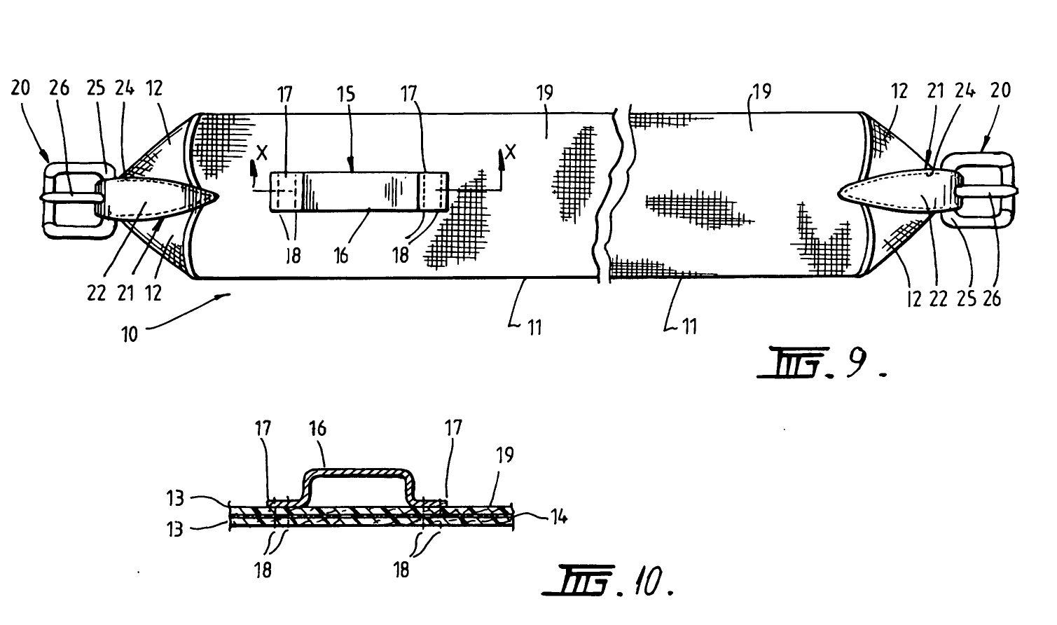

Referring to FIGS. 5 to 10 there is shown another embodiment of a girth strap device 10 in accordance with the invention. The strap device 10 comprises an elongate band 11 of extensible elastomeric material with attachment means in the form of buckles 20 provided at each end 12 of the band 11 for attaching the strap device to a saddle in such a manner that the strap device 10 extends around the chest of a horse such as illustrated in FIG. 1.

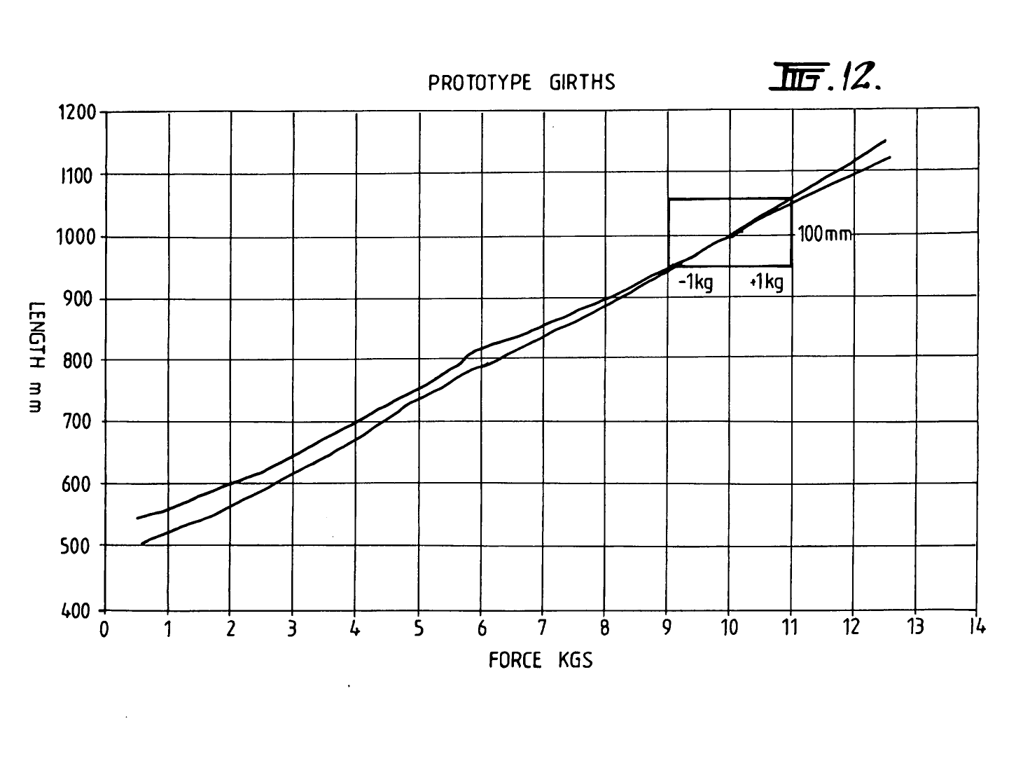

The strap device of FIGS. 5 to 10 includes a tension indicator 15 in the form of a length of fabric material 16 having its ends 17 secured to the elongate band 11, e.g. by stitching 18 or an adhesive. As shown in FIGS. 6 and 10, the length of material 16 between the stitched ends of the indicator 15 is arranged to form a loop which extends upwardly from the upper surface 19 of the band 11 when the strap device 10 is in an unstretched condition as shown in FIGS. 5 and 6.

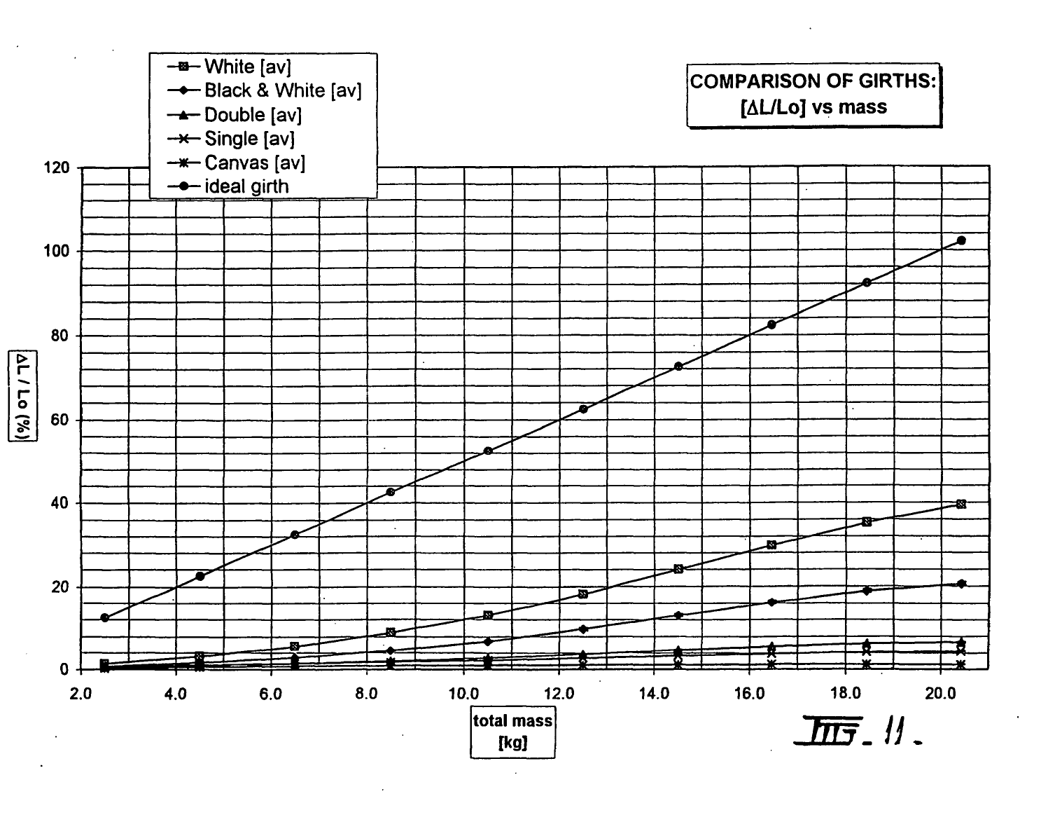

When the strap device 10 is stretched as shown in FIGS. 7 and 8, e.g. when the strap device 10 is fitted around the chest of a horse, the loop formed by the length of material 16 between the secured ends 17 flattens as the band 11 of the strap device 10 stretches, until the band 11 is stretched to a length which corresponds to a selected optimal tension to be applied to the horse. In this position the length of material 16 lies fully flat against the upper surface 19 of the band 11.

When the length of material 16 is fully flattened against the surface of the band 11, the user then knows that the selected optimal tension has been reached. The length of material 16 is preferably formed from an elastic material having a different elasticity to that of the elastomeric band 11, and the material 16 and the band 11 may also be provided with calibrated markings similar to the embodiment of FIG. 4. This can prevent the user from overtightening the girth strap on an animal.

As shown particularly in FIG. 9 the end portions 12 of the elongate extensible band 11 are folded inwardly to form V-shaped ends. The buckles 20 are attached to the end portions 12 by securing members 21 which have upper and lower portions 22, 23 that are secured, e.g. by stitching 24, to the upper and lower surfaces of the end portions 12 of the band 11. Each securing member 21 provides apertures which receive the rear part 25 of a respective buckle 20 on which the buckle pin 26 is mounted.

In a particularly preferred embodiment which is adapted for use with thoroughbred racehorses, the unextended length Lo of the elastomeric band 11 (including the end portions 12 but excluding the buckles 20) falls substantially within the range from about 500 mm to 800 mm, and is preferably about 700 mm. Such a band 11 made from neoprene or other similar elastomeric material is designed to stretch by about 50% of its unextended length, e.g. as illustrated by FIGS. 8 and 9, to apply a selected tension of about 10 kg to a horse.

A preferred width for the band 11 of the strap device in its unextended condition is from about 75 mm (3 inches) to about 127 mm (4 inches) and more preferably about 90 mm. It will, however, be appreciated that the width of the band 11 will decrease as the strap device 10 is extended to stretch the band 10. Further, the width of the band may vary for different applications.

As shown in FIGS. 7 and 8, when the length L of the band 11 has been stretched to approximately 50% of its original length Lₒ, the intermediate length of material 16 of the tension indicator 15 between the secured ends 17 lies substantially flat on the upper surface 19 of the band 11 to indicate that the band 11 has stretched to apply the selected tension to the girth strap.

The graph in FIG. 11 shows a comparison of a stretch characteristic represented by percentage of girth strap extension (ΔL/Lo) against applied tension (total mass [kg]) for conventional girth straps and for an ideal girth strap determined by research.

Of the conventional girth straps, Canvas [av] refers to a traditional girth strap of canvas material with buckles at each end; Single [av] refers to a girth strap having a canvas band with an elastic attachment at one end; Double [av] refers to a girth strap having a canvas band with elastic attachments at both ends; Black & White [av] refers to a full elastic girth strap; and White [av] refers to an “American Elastic” girth strap.

This stretched position of optimal tension is indicated to the person tightening the girth strap device 10 around the horse by the flat condition of the tension indicator 15.

In a preferred form of the girth strap device 10, illustrated particularly by the sectional view of FIG. 10, the elongate extensible band 11 is formed as a laminated construction consisting of a plurality of layers 13 of elastomeric material secured together. The synthetic elastomeric material neoprene in its flexible foam fabric form has been found to be particularly suitable for use as an extensible band in the girth strap device of the invention because it is relatively soft and has consistent stretch characteristics. It will, however, be appreciated that other natural or synthetic elastomeric materials similar to neoprene may be used to form the band of the strap device of the present invention.

The layers 13 of elastomeric material forming the laminated band are preferably banded together by an elastomeric adhesive 14 which has similar stretch characteristics to the layers 13 of elastomeric fabric material. For example, a thermoplastic elastomeric adhesive, such as a polyeurethane thermoplastic elastomer, may be used to bond together layers of neoprene fabric or the like.

It will be apparent from FIG. 11 that the stretch characteristic for an ideal girth strap is significantly higher than the best of the conventional girth straps, the American Elastic girth strap. For example, for applied tensions falling between 8 kg and 12 kg, the optimal range of tension for a girth strap for a thoroughbred racehorse, the ideal girth strap extensions vary from 40% to 60% in a linear manner, with an optimal girth strap extension of 50% for an applied tension of 10 kg.

FIG. 12 shows a graph of the stretch characteristics of two prototype girth straps constructed in accordance with the embodiment of FIGS. 5 to 10. In this graph the stretch characteristic is represented by total length of the band 11 of the girth strap device against the applied tension force. It will be seen from FIG. 12 that the prototype girth straps of the invention have a substantially linear extension characteristic, particularly in the region of the optimal applied tension of 10 kg.

Further, experiments have shown that a horse's girth expands by about 10% when the horse is breathing during vigorous movement. In order to maintain the applied tension within + or −1 kg of the optimal applied tension, a gradient of about 5% extension per kg of applied tension is required as indicated by FIG. 11. It will be apparent from FIG. 12, that particularly in the region of the optimal applied tension of 10 kg, the prototype girth straps of the invention provide about 5% extension per kg.

The invention as described could provide for a variety of applications with varying tension calibrations where, in the case of a girth strap for a horse, tension calibrations ranging from about 5 to 20 kg may be appropriate. In addition to the above embodiments, the invention could also apply to straps and accessories for providing bodily support. In particular, an embodiment in the form of a brassier for human use is envisaged within the scope of the current application. In the case of such an application, the tension calibration would be provided as appropriate to the build of the wearer.

The invention provides for the first time a ready means of adjusting strap tension in any one of a number of applications where objects are fitted to an animal or parts of an animal are supported by way of straps and other devices fitted to the animal's chest region. The particular material used for the strap means is not constrained by the invention and the invention can provide a readily retrofittable accessory for use in readily available devices or alternatively can be tailor made to be integrally incorporated in such devices. The inbuilt and readily used visual tension indicator provides a ready reference for users to apply such devices for best athletic performance and in a more general sense provides a ready means of calibrating and monitoring the manner in which such devices are fitted.

It will be appreciated that various modifications may be made to the preferred embodiments described above without departing from the scope and spirit of the invention.

1. A strap device comprising a strap means adapted to extend around the chest region of an animal and attachment means for attaching the ends of the strap means to an article, so that the strap means can be held in tension about the chest region of the animal, wherein the strap means is formed from an extensible elastomeric fabric material having a pre-calibrated substantially uniform extension characteristic in the region of an optimum applied tension, and the strap device includes a tension indicator to allow a user to apply the strap means to the animal at a selected calibrated tension.

2. A strap device according to claim 1 wherein the tension indicator is a visual indicator for indicating when the strap means has assumed the selected calibrated tension about the chest region of the animal.

3. A strap device according to claim 1 wherein the tension indicator is incorporated in the strap means.

4. A strap device according to claim 1 wherein the tension indicator is an accessory for fitting to the strap means.

5. A strap device according to claim 1 wherein the tension indicator and the strap means are adapted for relative movement when the strap means is extended.

6. A strap device according to claim 5 wherein the tension indicator includes at least one visual marking which is adapted to align with a marking on the strap means when a predetermined tension is applied to the strap.

7. A strap device according to claim 6 wherein the tension indicator and/or the strap device has a plurality of calibrated visual markings.

8. A strap device according to claim 7 wherein the visual markings are calibrated for a range of applied tensions around an optimum applied tension between about 5 kg and about 20 kg.

9. A strap device according to claim 1 wherein the indicator comprises a thong attached to securing means for a buckle at one end of the strap means.

10. A strap device according to claim 1 wherein the indicator comprises an insert of different elasticity to that of the strap means.

11. A strap device according to claim 1 wherein the indicator is a length of material attached at its ends to the strap means at a position adjacent the attachment means at at least one end of the strap means to form a loop above a surface of the strap means in the unextended condition of the strap means and which is adapted to lie flat against the strap means when the strap means is extended to the selected tension.

12. A strap device according to claim 1 wherein the attachment means comprises buckles provided at the ends of the strap means for attaching the strap device to an article, such as a saddle.

13. A strap device according to claim 1 wherein the strap means comprises a single elongate band of extensible elastomeric material which is able to stretch substantially uniformly during breathing of the animal at tensions above the optimum applied tension.

14. A girth strap device comprising an elongate band adapted to extend around the chest region of an animal and attachment means for securing the strap device to a saddle, wherein the elongate band is formed from an extensible elastomeric fabric material that is adapted to stretch around the chest of an animal, said band having a pre-calibrated substantially uniform extension characteristic in the region of an optimum applied tension, whereby a calibrated selected tension is applied to the animal when the elongate band has been stretched longitudinally by a selected amount, and the elongate band stretches substantially uniformly during breathing of the animal at tensions above the optimum applied tension.

15. A girth strap device according to claim 14 wherein the strap device is adapted to apply a selected tension falling substantially within the range from 5 kg to 20 kg.

16. A girth strap device according to claim 15 wherein the strap device is adapted to apply a selected tension falling substantially within the range from 10 kg to 15 kg.

17. A girth strap device according to claim 14 wherein the band of elastomeric material is adapted to extend in length from about 3% to about 7% per kg of tension applied to the band.

18. A girth strap device according to claim 17 wherein the band is adapted to extend in length by about 5% per kg of tension applied to the band.

19. A girth strap device according to claim 14 wherein the band is adapted to extend in length from about 30% to about 70% of its unextended length to apply the selected tension to the animal.

20. A girth strap device according to claim 19 wherein the band is adapted to extend in length from about 40% to about 60% of its unextended length to apply the selected tension.

21. A girth strap device according to claim 20 wherein the elastomeric material used for the band is such that the band extends by about 50% of its unextended length to provide a selected tension of about 10 kg.

22. A girth strap device according to claim 14 wherein the selected tension is indicated by a tension indicator.

23. A girth strap device according to claim 1 wherein the elongate band or strap means is formed from neoprene or other flexible foam elastomer.

24. A girth strap device according to claim 1 wherein the elongate band or strap means is a laminated construction of at least two layers of elastomeric fabric material.

25. A girth strap device comprising a single elongate band adapted to extend around the chest region of an animal, and attachment means at each end of the band for securing the strap device to an article, wherein the single elongate band is a laminated construction of at least two layers of elastomeric fabric material having a pre-calibrated substantially uniform extension characteristic in the region of an optimum applied tension.

26. A girth strap device according to claim 25 wherein the layers of elastomeric fabric material are formed from neoprene or other similar flexible foam material.

27. A girth strap device according to claim 25 wherein the layers of elastomeric fabric material are bonded together by an elastomeric adhesive.

28. A girth strap device according to claim 27 wherein the elastomeric adhesive has similar stretch characteristics to the layers of elastomeric fabric material.

29. A girth strap device according to claim 28 wherein the elastomeric adhesive is a thermoplastic elastomer.

30. A method of fitting a girth strap device in accordance with claim 1 to a horse, wherein the girth strap is tightened to a selected tension falling substantially within the range from about 5 kg to about 20 kg.

31. A method of fitting a girth strap according to claim 30 wherein the girth strap is tightened to a selected tension falling substantially within the range from about 10 kg to about 15 kg.

32. A method according to claim 30 wherein a tension indicator is used to indicate when the girth strap has been tightened to a selected tension.

33. A girth strap device according to claim 14 wherein the elongate band or strap means is formed from neoprene or other flexible foam elastomer.

34. A girth strap device according to claim 14 wherein the elongate band or strap means is a laminated construction of at least two layers of elastomeric fabric material.

35. A girth strap device according to claim 24 wherein the layers of elastomeric fabric material are formed from neoprene or other similar flexible foam material.

36. A girth strap device according to claim 24 wherein the layers of elastomeric fabric material are bonded together by an elastomeric adhesive.

37. A girth strap device according to claim 36 wherein the elastomeric adhesive has similar stretch characteristics to the layers of elastomeric fabric material.

38. A girth strap device according to claim 37 wherein the elastomeric adhesive is a thermoplastic elastomer.

39. A girth strap device according to claim 34 wherein the layers of elastomeric fabric material are formed from neoprene or other similar flexible foam material.

40. A girth strap device according to claim 34 wherein the layers of elastomeric fabric material are bonded together by an elastomeric adhesive.

41. A girth strap device according to claim 40 wherein the elastomeric adhesive has similar stretch characteristics to the layers of elastomeric fabric material.

42. A girth strap device according to claim 41 wherein the elastomeric adhesive is a thermoplastic elastomer.

43. A method of fitting a girth strap device in accordance with claim 14 to a horse, wherein the girth strap is tightened to a selected tension falling substantially within the range from about 5 kg to about 20 kg.

44. A method of fitting a girth strap device in accordance with claim 25 to a horse, wherein the girth strap is tightened to a selected tension falling substantially within the range from about 5 kg to about 20 kg.
